(19) United States
(12) Patent Application Publication
(10) Pub. No.: US 2014/0048546 A1
(43) Pub. Date: Feb. 20, 2014

(54) Collapsible Container

(71) Applicant: Henricus Johannes Cornelis Lamberdina Kennis, Veghel (NL)

(72) Inventor: Henricus Johannes Cornelis Lamberdina Kennis, Veghel (NL)

(73) Assignee: BIGBAGBOX INTERNATIONAL, INC., Marietta, GA (US)

(21) Appl. No.: 13/587,404

(22) Filed: Aug. 16, 2012

(51) Int. Cl. B65D 8/04; B31B 1/26

(52) U.S. Cl. 220/666; 493/405

(57) ABSTRACT

Included are embodiments for a collapsible container. At least one embodiment of the present disclosure includes a bottom panel; two first side walls, each of the first side walls being adjoined to a corresponding first edge of the bottom panel; two second side walls, each of the second side walls being adjoined to a corresponding second edge of the bottom panel; a border reinforcement, the border reinforcement being adhesively fastened relative to a top portion of each of the first side walls and each of the second side walls; and a mechanism for carrying the collapsible container.

### BACKGROUND

Plastic bags are associated with numerous problems in the environment. For example, plastic bags are not biodegradable, have a negative impact on marine life, and cause other problems. Accordingly, increased amounts of paper bags are being used. However, conventional paper bags also have a variety of shortcomings, including lack of durability for repeated use, storage, space requirements and difficulty of carrying.

### SUMMARY

Included are embodiments for a collapsible container. At least one embodiment of the present disclosure includes a bottom panel; two first side walls, each of the first side walls being adjoined to a corresponding first edge of the bottom panel; two second side walls, each of the second side walls being adjoined to a corresponding second edge of the bottom panel; a border reinforcement, the border reinforcement being adhesively continuously disposed along to a top portion of each of the first side walls and each of the second side walls; and a mechanism for carrying the container. The container extends to form the shape of a box when in an unfolded state. The container also folds and lies flat such that the top edges of the second side walls are aligned with a corresponding one of the second edges of the bottom panel.

Other embodiments and/or advantages of this disclosure will be or may become apparent to one with skill in the art upon examination of the following drawings and detailed description. It is intended that all such additional units, methods, features, and advantages be included within this description and be within the scope of the present disclosure.

### BRIEF DESCRIPTION

Many aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views. While one exemplary embodiment is described in connection with these drawings, there is no intent to limit the disclosure to the embodiment disclosed herein. On the contrary, the intent is to cover all alternatives, modifications, and equivalents.

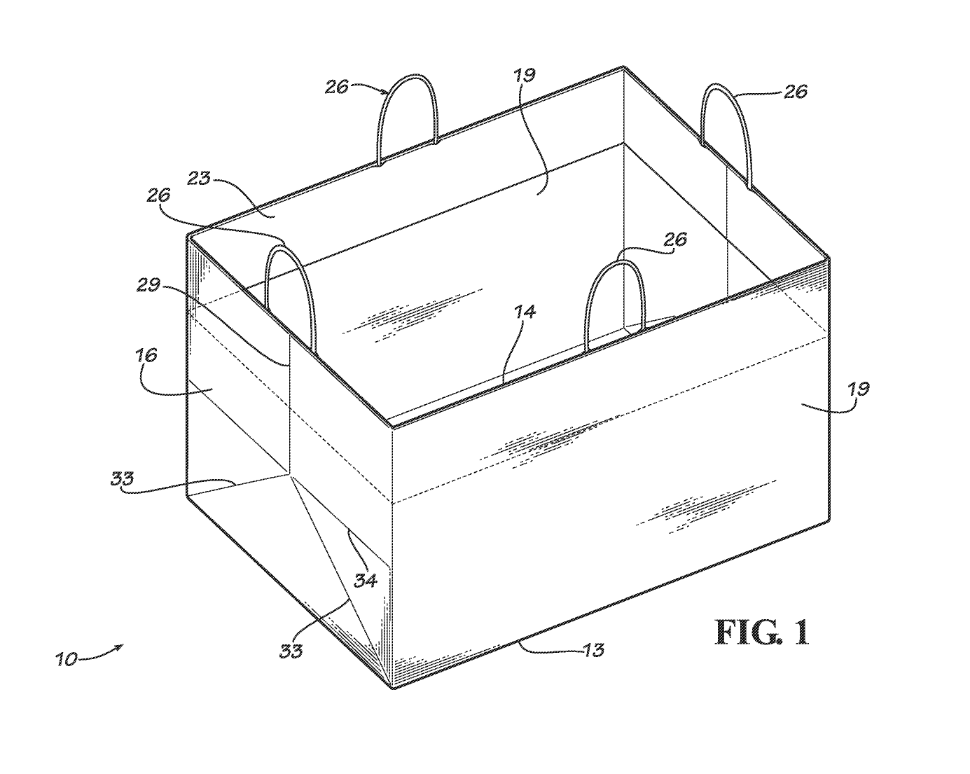

FIG. 1 shows the container unfolded, open and ready for use.

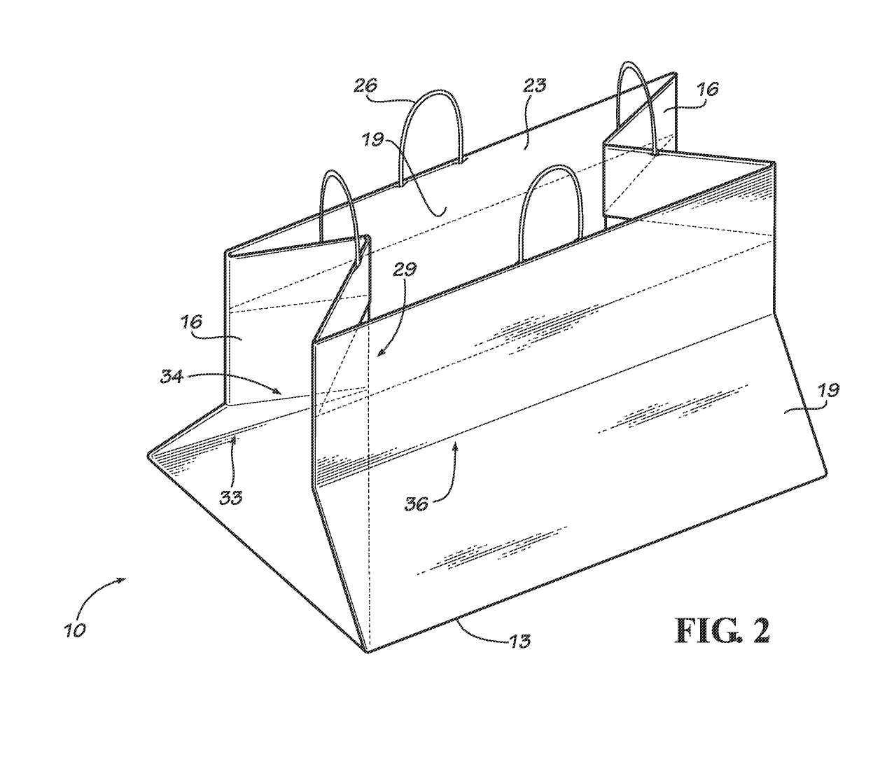

FIG. 2 shows the container partially folded.

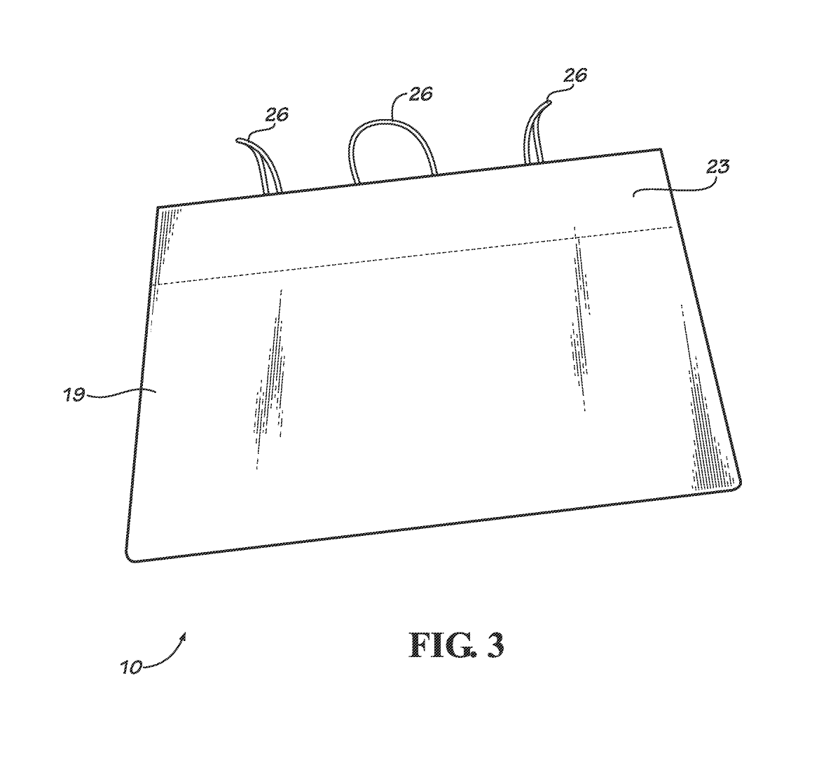

FIG. 3 shows the container collapsed and closed.

### DETAILED DESCRIPTION

FIG. 1 illustrates an exemplary container 10, which may be a collapsible container, in an open position that includes a bottom panel 13, two first side walls 16, two second side walls 19, a border reinforcement portion 23, and one or more handles 26. Each of the first side walls 16 is adjoined to a corresponding first edge of the bottom panel 13. Each of the second side walls 19 is adjoined to a corresponding second edge of the bottom panel 13. The border reinforcement portion 23 is, in this non-limiting example, attached to a top portion of the first side walls 16 and a top portion of the second side walls 19.

Collapsible container 10 may be configured in any of a number of materials, as one of ordinary skill in the art would know. As nonlimiting examples, collapsible container may be configured of a fiber-based material, such as paper, plastic, fiberboard, cardboard, and/or any other material as described herein.

In the non-limiting example shown in FIG. 1, the edge formed by second side wall 19 and bottom panel 13 is greater in length than the edge formed by first side wall 16 and side wall 19. This dimension gives container 10 a rectangular box shape when open, that is, such that container 10 is wider than it is tall. It should be noted, however, that in another non-limiting example, the edge formed by second side wall 19 and bottom panel 13 may be substantially equal in length to the edge formed by first side wall 16 and side wall 19. In this configuration, the bottom panel 13 may be substantially square.

Handles 26 may comprise apertures, straps, and/or other mechanisms for carrying the container 10, as one of ordinary skill in the art would know. Handles 26 may be secured to container 10 at border reinforcement portion 23. Instead of the handles 26 shown in FIG. 1, straps and/or other carrying/support mechanisms may be implemented, as one of ordinary skill in the art would know.

The border reinforcement portion 23 may comprise a semi-rigid material, such as, for example, paperboard, cardboard, kraft paper, corrugated fiberboard, plastic, and/or other material. Border reinforcement portion 23 may comprise one or more bonded pieces of material to provide added strength to container 10. Similarly, the bottom panel 13 may comprise a semi-rigid material, such as, for example, paperboard, cardboard, kraft board, corrugated fiberboard, and/or other material.

In an open position, container 10 may exhibit qualities of a box in that container 10 and its portions, as described above, may provide rigid support for transporting and/or packaging objects, products, and/or other items. In this respect, the border reinforcement portion 23 may provide additional support for each of the first side walls 16 and each of the second side walls 19 such that the container 10 can generally obtain a box shape with additional shape stability. In this respect, the border reinforcement portion 23 may provide additional support to help to prevent and/or minimize tearing when the container 10 is carried using one or more handles 26.

As illustrated in the non-limiting example of FIG. 1, each of first side walls 16 may include a first fold line 29. The first fold line 29 may extend along a central portion of the respective first side wall 16. Each of the first fold lines 29 in this non-limiting example may be substantially and/or approximately perpendicular to a respective first edge of the bottom panel 13.

In addition, each of the first side walls 16 may include two or more second fold lines 33. Each of the second fold lines 33 may extend diagonally from a corresponding corner of the respective first side wall 16 to the respective one of the first fold lines 29. In addition, each of the first side walls 16 may also include a corresponding third fold line 34. The third fold line 34 may extend parallel to a respective edge of the bottom panel 10 and intersect the respective fold line 29 at a central point.

As a non-limiting alternative embodiment, container 10 may also include a support portion 14 that may be positioned inside container 10 on top of bottom panel 13. Support portion 14 may comprise materials of increased strength for supporting heavier loads in container 10, such as, as a nonlimiting example, corrugated cardboard. Support portion 14 may be configured to either be permanently attached to bottom panel 13 by, for example, glue or other fastening techniques, as one of ordinary skill in the art would know, or it may be configured to merely rest in the bottom of container 10 to be removed, as needed.

FIG. 2 illustrates an alternative view of the exemplary container 10 from FIG. 1. As illustrated in the non-limiting example of FIG. 2, the container 10 may include two second side walls 19. Each of the second side walls 19 may include a corresponding fourth fold line 36. Each of the fourth fold lines 36 may extend across the length of the respective second side wall 19 parallel.

On first side wall 16, the first fold lines 29, the second fold lines 33, third fold lines 34 and the fourth fold lines 36 are configured to make it easier to fold, collapse, expand, unfold, and/or otherwise manipulate the container 10, as depicted in FIG. 2. As shown in the non-limiting example of FIG. 2, each of the first fold lines 29 enable the first side walls 16 to be folded inward towards the center of the container 10. The second fold lines 33 enable the container 10 to be folded downward towards the bottom panel 13.

FIG. 3 illustrates a collapsed view of the exemplary container 10 from FIG. 1. The third fold lines 34 (shown in FIG. 2) and the fourth fold lines 36 (shown in FIG. 2) enable the container 10 to be folded to a respective side of the bottom panel 10 and allow the container 10 to collapse and lay flat, as shown in the non-limiting example of FIG. 3. In this configuration, container 10 exhibits qualities of a foldable bag.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A collapsible container comprising:
a bottom panel having a first pair of edges and a second pair of edges, the first pair of edges being shorter in length than the second pair of edges;
two opposing first side walls, each of the first side walls being adjoined to a corresponding one of the first pair of edges, wherein the height of the first side walls is less than the length of the first pair of edges;
two opposing second side walls, each of the second side walls being adjoined to a corresponding one of the second pair of edges wherein the height of the second side walls is less than the length of the first pair of edges; and
a border reinforcement portion disposed along a respective top portion of one or more of the first and second opposing side walls, wherein the border reinforcement portion is a second semi-rigid material, and wherein the collapsible container is configurable to form a box-like container and is configurable to collapse to form into a relatively flattened shape.

2. The collapsible container of claim 1, further comprising a plurality of handles coupled to a border reinforcement portion.

3. The collapsible container of claim 2, wherein the number is handles is greater than two.

4. The collapsible container of claim 1, wherein each of the bottom panel and the first and second opposing side walls is comprised of a fiber-based product.

5. The collapsible container of claim 1, wherein each of the bottom panel and the first and second opposing side walls is comprised of paper.

6. The collapsible container of claim 1, further comprising:
a panel insert portion configured approximately the size of the bottom panel, wherein the panel insert portion may be positioned within the collapsible container on top of the bottom panel.

7. The collapsible container of claim 6, wherein the panel insert portion is fastened to the bottom panel.

8. The collapsible container of claim 6, wherein the panel insert portion is a corrugated material.

9. The collapsible container of claim 1, further comprising one or more straps coupled to the collapsible container.

10. A method for collapsing a collapsible container, the method comprising the steps of:
folding each of two opposing first side walls along a plurality of fold lines in each opposing first side wall, each of the first side walls being adjoined to a corresponding one of a first pair of edges of a rectangular-shaped bottom panel;
folding each of two opposing second side walls along a fold line in each opposing second side wall, each of the second side walls being adjoined to a corresponding one of a second pair of edges of the rectangular-shaped bottom panel, wherein the height of each of the opposing first and second side walls is less than the longer of the first and second pair of edges of the rectangular-shaped bottom panel; and
folding one of the two opposing second sides about the fold line in the opposing second side so that the one of the two opposing second sides folds over onto a portion of itself and so that the second of the two opposing second sides comes into a relatively parallel orientation with respect to the rectangular-shaped bottom portion; and
wherein a plurality of handles is coupled to one or both of the first and second two opposing side walls at a reinforced section of the one or both of the first and second two opposing side walls.

11. The method of claim 10, wherein the collapsible container is configured as a box-like container when the one of the two opposing second sides and the second of the two opposing second sides is in a relatively perpendicular orientation with respect to the rectangular-shaped bottom portion.

12. The method of claim 10, further comprising the step of:
fastening a support portion to a top side of the rectangular-shaped bottom portion.

13. The method of claim 12, wherein the support portion is comprised of corrugated material.

14. The method of claim 10, wherein the number of handles coupled to the collapsible container is four.

15. The method of claim 10, wherein the plurality of handles are configured as straps.

16. The method of claim 10, wherein each of the first and second side walls and the rectangular-shaped bottom panel comprises a paper-based material.

17. A collapsible container comprising:
bottom panel means for supporting a load, the bottom panel means having a first pair of parallel edges shorter than a second pair of parallel edges;
two opposing first side wall means for defining a box wall short side portion, the two opposing first side wall means being adjoined to a corresponding one of the first pair of parallel edges, wherein each of the two opposing the first side wall means has a height that is less than a length of the first pair of parallel edges;
two opposing second side wall means for defining a box wall long side portion, the two opposing second side wall means being adjoined to a corresponding one of the second pair of parallel edges, wherein each of the two opposing second side wall means has a height that is less than a length of the first pair of parallel edges; and
means for reinforcing a border portion of one or more of the first and second opposing side wall means, wherein the collapsible container is configurable to form a box-like container when the two opposing second side wall means is relatively perpendicular to the bottom panel means; and
means for carrying the collapsible container.

18. The collapsible container of claim 17, further comprising:
means for increasing a load capacity of the collapsible container, the means for increasing coupled to a top portion of the bottom panel means.

19. The collapsible container of claim 17, wherein the collapsible container is comprised of a paper-based material.

20. A collapsible container comprising:
a bottom panel having a first pair of edges and a second pair of edges, the first pair of edges being substantially equal in length to the second pair of edges;
two opposing first side walls, each of the first side walls being adjoined to a corresponding one of the first pair of edges, wherein the height of the first side walls is substantially equal to the length of the first pair of edges;
two opposing second side walls, each of the second side walls being adjoined to a corresponding one of the second pair of edges wherein the height of the second side walls is substantially equal to the length of the first pair of edges; and
a border reinforcement portion disposed along a respective top portion of one or more of the first and second opposing side walls, wherein the border reinforcement portion is a second semi-rigid material, and wherein the collapsible container is configurable to form a box-like container and is configurable to collapse to form into a relatively flattened shape.
